(19) United States
(12) Patent Application Publication
(10) Pub. No.: US 2014/0111428 A1
(43) Pub. Date: Apr. 24, 2014

(54) REMOTE CONTROL SYSTEM AND METHOD FOR COMPUTER

(71) Applicant: TEN-CHEN HO, New Taipei (TW)

(72) Inventor: TEN-CHEN HO, New Taipei (TW)

(21) Appl. No.: 13/678,587

(22) Filed: Nov. 16, 2012

(30) Foreign Application Priority Data
Oct. 23, 2012 (CN) 2012104065557

(51) Int. Cl. G06F 3/0354

(52) U.S. Cl. CPC G06F 3/0354
USPC 345/157

(57) ABSTRACT

A remote control system includes a computer, a label device, a camera, a signal processing module, and an interface connected to a computer. The signal processing module stores a preset time interval, first and second preset distances, and first and second preset time. The camera captures images of the label device at an interval time and sends the images of the label device to the signal processing module. The signal processing module obtains a movement distance and a movement time of the label device according to the received images, and compares the movement distance with the first and second preset distances and also compares the movement time with the first and second preset time, to output a first instruction, a second instruction, a third instruction, or a fourth instruction to control a cursor of the computer.

### BACKGROUND

1. Technical Field

The present disclosure relates to remote control systems and remote control methods, and particularly to a remote control system and a remote control method for a computer.

2. Description of Related Art

Conventionally, a computer is operated by a keyboard and a mouse. The mouse, for example, can be used to select, open, or close menus. However, the mouse must be physically close to the computer and the user must be physically close (within hand reach) of the mouse. However, this limits the movement range of the user of the computer, which is inconvenient for the user, and for some computer mice, the clicking sound of the buttons may be annoying to nearby personnel.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is a schematic diagram of a remote control system for a computer in accordance with an exemplary embodiment of the present disclosure.

FIG. 2 is a block diagram of FIG. 1.

FIGS. 3a and 3b are flowcharts of a remote control method for a computer in accordance with an exemplary embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

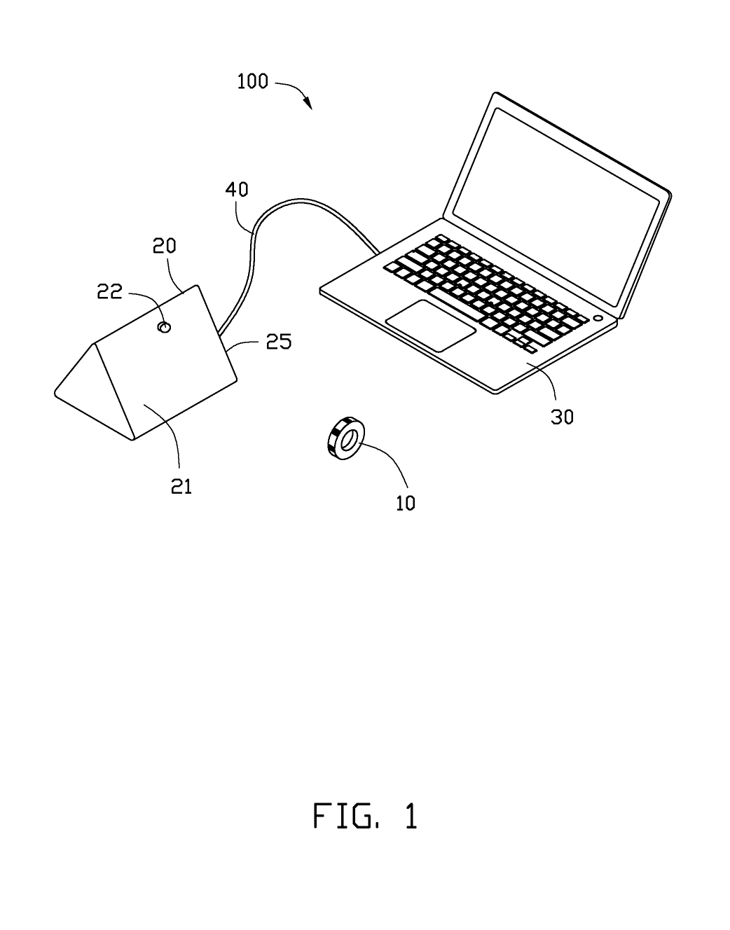

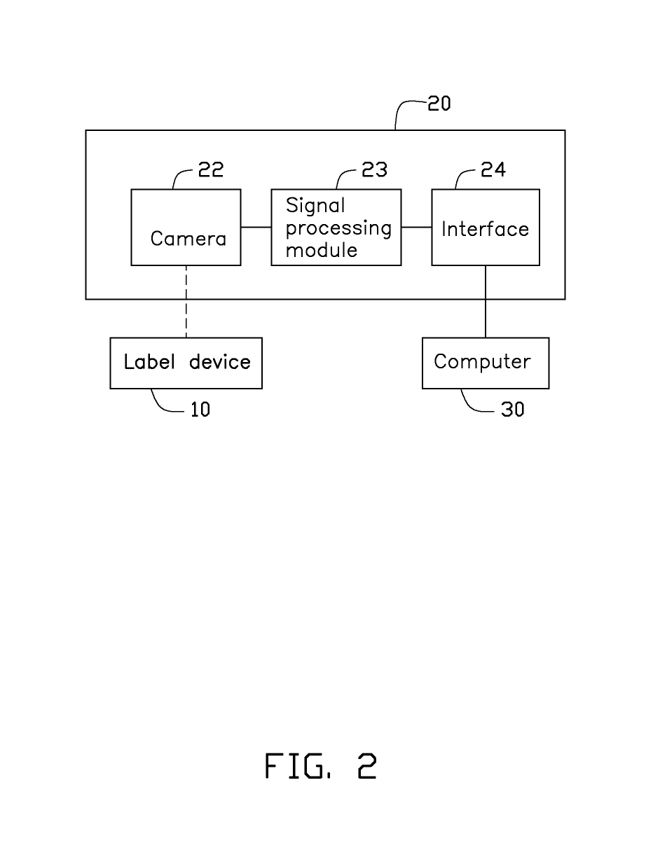

FIGS. 1 and 2 show a remote control system in accordance with an exemplary embodiment. The remote control system includes a label device 10, a processing device 20, and a computer 30. In one embodiment, the label device 10 may be ring-shaped. In one embodiment, the processing device 20 is triangular prism-shaped. A camera 22 is located on a sidewall 21 of the processing device 20. A signal processing module 23 is arranged inside the processing device 20. An interface 24, such as a universal serial bus (USB) interface, is located in an end wall 25 of the processing device 20. The processing device 20 is connected to the computer 30 through the interface 24 and a cable 40. The signal processing module 23 stores a preset time interval, a first preset distance (such as 3 centimeters), a second preset distance (such as 5 centimeters), a first preset time (such as 1 second), and a second preset time (such as 3 seconds).

When the computer 30 operates, the camera 22 captures images of the label device 10 at same preset time interval and sends the captured images to the signal processing module 23. The signal processing module 23 obtains a movement distance and a movement time of the label device 10 according to the received images, and compares the movement distance with the first and second preset distances and also compares the movement time with the first and second preset time. When the movement distance is less than the first preset distance and the movement time is less than the first preset time, the signal processing module 23 outputs a first key-press instruction to the computer 30 for controlling a cursor to emulate a left-button operation of a mouse, such as a click for the left-button of the mouse.

When the movement distance is greater than the first preset distance and less than the second preset distance, and the movement time is greater than the first preset distance and less the second preset time, the signal processing module 23 outputs a second key-press instruction to the computer 30 for controlling the cursor to emulate a right-button operation of the mouse, such as a double click for the left-button or a click for the right-button of the mouse. When the movement distance is greater than the second preset distance and a track of the movement distance is not a circle, and the movement time is greater than the second preset time, the signal processing module 23 outputs a movement instruction to the computer 30 for controlling the cursor to execute a spatial movement as if in response to a sliding movement of the mouse. When the movement distance is greater than the second preset distance and a track of the movement distance is a circle, and the movement time is greater than the second preset time, the signal processing module 23 outputs a rolling instruction to the computer 30 for controlling the cursor to execute a scrolling operation as if in response to a rolling of the wheel of the mouse.

In use, the processing device 20 is connected to the computer 30 and the computer 30 is operated, and the label device 10 is worn on a finger of a user or held in a hand of the user. When the label device 10 is moved from a first position to a second position, the camera 22 captures images of the label device 10 and sends the images to the signal processing module 23 systematically. The signal processing module 23 obtains the movement distance and the movement time of the label device 10 according to the received images. If the movement distance of the label device 10 is 2 centimeters and the movement time of the label device 10 is 0.5 seconds, the signal processing module 23 outputs a first key-press instruction to the computer 30 for controlling the cursor to to emulate a left-button operation of a mouse. If the movement distance of the label device 10 is 4 centimeters and the movement time of the label device 10 is 2 seconds, the signal processing module 23 outputs a second key-press instruction to the computer 30 for controlling the cursor to emulate a right-button operation of the mouse. If the movement distance of the label device 10 is 6 centimeters and a track of the movement distance is not a circle, and the movement time of the label device 10 is 4 seconds, the signal processing module 23 outputs a movement instruction to the computer 30 for controlling the cursor to execute a spatial movement as if in response to a sliding movement of the mouse. If the movement distance of the label device 10 is 6 centimeters and a track of the movement distance is a circle, and the movement time of the label device 10 is 4 seconds, the signal processing module 23 outputs a rolling instruction to the computer 30 for controlling the cursor to execute a scrolling operation as if in response to a rolling of the wheel for the mouse.

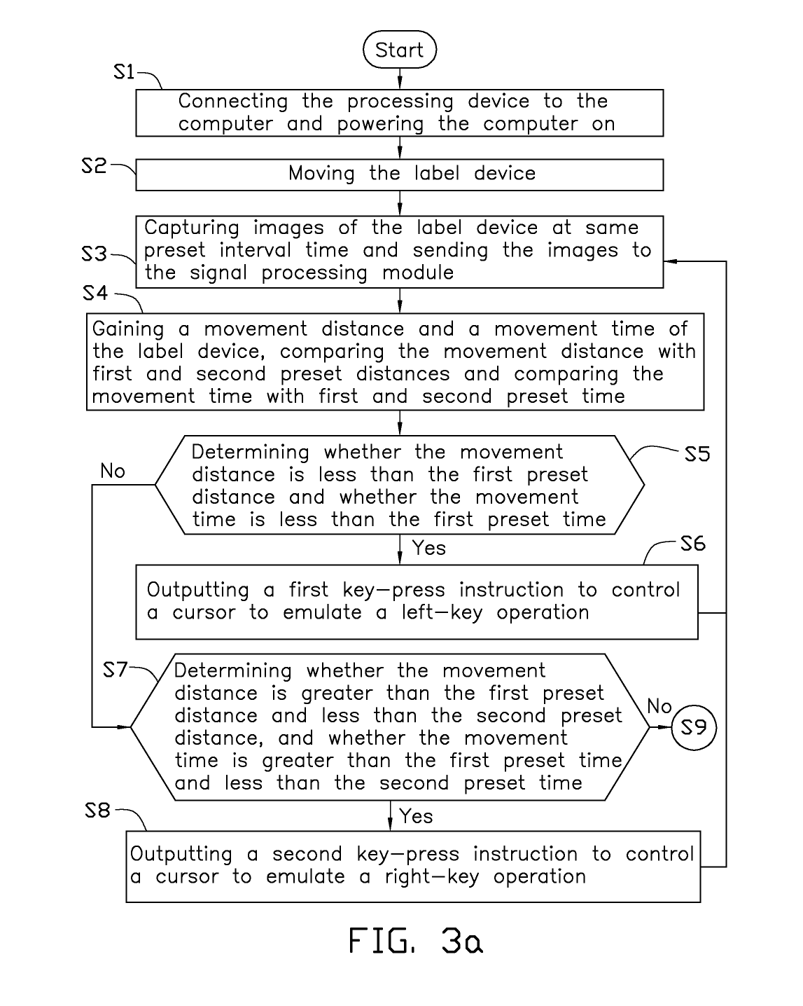

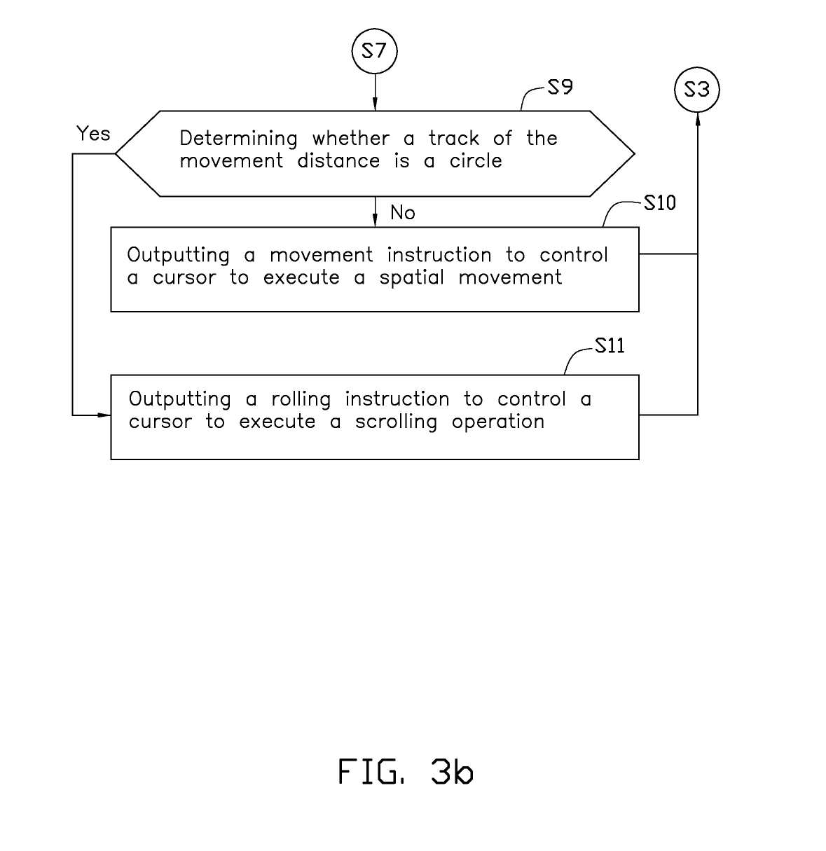

FIGS. 3a and 3b show an exemplary embodiment of a remote control method for the computer 30 including the following steps.

In step S1, the processing device 20 is connected to the computer 30 through the interface 24, and the computer 30 is operated.

In step S2, the label device 10 is moved.

In step S3, the camera 22 captures images of the label device 10 at an a preset time interval and sends the images to the signal processing module 23.

In step S4, the signal processing module 23 obtains the movement distance and the movement time of the label device 10 according to the received images, and compares the movement distance with the first and second preset distances and also compares the movement time with the first and second preset time stored in the signal processing module 23.

In step S5, a determination is made whether the movement distance is less than the first preset distance and whether the movement time is less than the first preset time. If the movement distance is less than the first preset distance and the movement time is less than the first preset time, the procedure goes to step S6. If the movement distance is not less than the first preset distance and the movement time is not less than the first preset time, the procedure goes to step S7.

In step S6, the signal processing module 23 outputs a first key-press instruction to the computer 30 for controlling the cursor to emulate the left-button operation of the mouse, and then the procedure goes back to step S3.

In step S7, a determination is made whether the movement distance is greater than the first preset distance and less than the second preset distance, and whether the movement time is greater than the first preset time and less than the second preset time. If the movement distance is greater than the first preset distance and less than the second preset distance, and the movement time is greater than the first preset time and less than the second preset time, the procedure goes to step S8. If the movement distance is greater than the second preset distance, and the movement time is greater than the second preset time, the procedure goes to step S9.

In step S8, the signal processing module 23 outputs a second key-press instruction to the computer 30 for controlling the cursor to emulate a right-button operation of the mouse, and then the procedure goes back to step S3.

In step S9, a determination is made whether a track of the movement distance of the label device 10 is a circle. If the track is a circle, the procedure goes to step S11. If the track is not a circle, the procedure goes to step S10.

In step S10, the signal processing module 23 outputs a movement instruction to the computer 30 for controlling the cursor to execute the spatial movement as if in response to a sliding movement of the mouse, and then the procedure goes back to step S3.

In step S11, the signal processing module 23 outputs a rolling instruction to the computer 30 for controlling the cursor to execute a scrolling operation as if in response to a rolling of the wheel for the mouse, and then the procedure goes back to step S3.

The remote control system generates corresponding operation actions in the computer 300 according to the free movement states of the label device 10. Therefore, the user of the computer 300 can remotely control the computer 300 conveniently.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A remote control system, comprising:
a computer;
a label device; and
a processing device comprising:
a camera to capture images of the label device;
a signal processing module connected to the camera, to receive the images of the label device from the camera, wherein the signal processing module stores a preset time interval, a first preset distance, a second preset distance, a first preset time, and a second preset time; and
an interface connected between the signal processing module and the computer;
wherein when the computer operates, the camera captures images of the label device at the preset time interval and sends the images to the signal processing module, the signal processing module obtains a movement distance and a movement time of the label device according to the received images, and compares the movement distance with the first and second preset distances and also compares the movement time with the first and second preset time, when the movement distance is less than the first preset distance and the movement time is less than the first preset time, the signal processing module outputs a first instruction to the computer for controlling a cursor of the computer; when the movement distance is greater than the first preset distance and less than the second preset distance and the movement time is greater than the first preset time and less than the second preset time, the signal processing module outputs a second instruction to the computer for controlling the cursor; when the movement distance is greater than the second preset distance and a track of the movement distance is not a circle and the movement time is greater than the second preset time, the signal processing module outputs a third instruction to the computer for controlling the cursor;
when the movement distance is greater than the second preset distance and a track of the movement distance is circle and the movement time is greater than the second preset time, the signal processing module outputs a fourth instruction to the computer for controlling the cursor.

2. The remote control system of claim 1, wherein the label device is ring-shaped.

3. The remote control system of claim 1, wherein the processing device is triangular prism-shaped, the camera is located on a sidewall of the processing device, the signal processing module is arranged inside the processing device, the interface is located on an end wall of the processing device.

4. A remote control method for a computer, comprising:
(a): moving a label device;
(b): capturing images of the label device through a camera at an preset time interval and sending the images to a signal processing module;
(c): obtaining a movement distance and a movement time of the label device according to the received images by the signal processing module, and comparing the movement distance with first and second preset distances and comparing the movement time with first and second preset time stored in a signal processing module by the processing module;
(d): determining whether the movement distance is less than the first preset distance and whether the movement time is less than the first preset time;
(e): outputting a first instruction to control the cursor in response to the movement distance being less than the first preset distance and the movement time being less than the first preset time, and then the procedure going back to step (b);
(f): determining whether the movement distance is greater than the first preset distance and less than the second preset distance, and the movement time is greater than the first preset time and less than the second preset time, in response to the movement distance being not less than the first preset distance and the movement time being not less than the first preset time;
(g): outputting a second instruction to control the cursor in response to the movement distance being greater than the first preset distance and less than the second preset distance, and the movement time being greater than the first preset time and less than the second preset time, and then the procedure going back to step (b);
(h): determining whether a track of the movement distance is a circle in response to the movement distance being greater than the second preset distance and the movement time being greater than the second preset time;
(i): outputting a third instruction to control the cursor in response to the track of the movement distance being not a circle, and then the procedure going back to step (b); and
(j): outputting a fourth instruction to control the cursor in response to the track of the movement distance being a circle, and then the procedure going back to step (b).
